(19) United States
(12) Patent Application Publication
(10) Pub. No.: US 2014/0278653 A1
(43) Pub. Date: Sep. 18, 2014

(54) Method And System For Optimizing Field Service Appoint Scheduling

(71) Applicants: Charles D. COCANOUGHER, Justin, TX (US); Robert A. Cocanougher, Southlake, TX (US); Stephen F. Chambers, Justin, TX (US); Bradley A. Dodd, Keller, TX (US)

(72) Inventors: Charles D. COCANOUGHER, Justin, TX (US); Robert A. Cocanougher, Southlake, TX (US); Stephen F. Chambers, Justin, TX (US); Bradley A. Dodd, Keller, TX (US)

(21) Appl. No.: 14/208,940

(22) Filed: Mar. 13, 2014

Related U.S. Application Data
(60) Provisional application No. 61/783,909, filed on Mar. 14, 2013.
(60) Provisional application No. 61/784,023, filed on Mar. 14, 2013.

(51) Int. Cl. G06Q 10/06

(52) U.S. Cl. CPC G06Q 10/063116
USPC 705/7.16

(57) ABSTRACT

A system and method for allowing a dispatcher and/or a service technician to achieve an optimized schedule for a few or a large number of service technicians performing repairs in the field based on an analysis of past data, methodologies and formulas, wherein a scheduling program is displayed to the dispatcher on a monitor of a computer or any other processing device, using the scheduling program the dispatcher calls up or accesses the current schedule of all the technicians, and the technicians can simultaneously view their entire current schedule and agree to a proposed appointment, even placing blocks on dates and times that they are not available for scheduling so that optimized or near optimized schedules are obtained quickly and economically.

### CROSS-REFERENCE TO RELATED APPLICATIONS

This application claims priority from U.S. Provisional Application Ser. Nos. 61/783,909 and 61/784,023 filed Mar. 14, 2013, the disclosure content of which are hereby incorporated by reference in their entirety.

### BACKGROUND OF THE INVENTION

1. Field of the Invention

The present invention generally relates to the field of task scheduling and, more particularly, to a system and method for obtaining a highly optimized, user friendly, schedule for multiple service technicians (techs) that are at multiple locations and who possess varying skills in a field service operation.

2. Description of the Related Art

Handheld electronic devices, such as personal digital assistants (PDAs) or mobile phones (smartphones), offer mobility and a variety of services to their respective users. While they are typically configured to transmit and receive data to and from other devices via a wired or wireless connection, most mobile communication devices can also provide Internet access, maintain a personal address book, provide messaging capabilities, capture digital images, and place phone calls. Many devices, such as smart phones and PDAs, provide a calendaring and/or “to-do list” function that allows the user to calendar appointments and to enter tasks directly into the device or into a service in a remote server. The calendaring function can be configured to provide a reminder of an appointment or task to the user at or near the time the appointment has been scheduled.

In the case of scheduling and calendar functions, an electronic calendar system is designed to maintain useful information for a user. Electronic calendar systems allow maintenance of a personal schedule of activities such as meeting appointments, teleconference schedules, service appointments vacation or business travel plans. Examples of electronic calendaring systems include Microsoft Outlook™ 2000, Lotus Organizer™, and Lotus Notes™. Such systems are quite popular among users. “Outlook” is a trademark of Microsoft Corporation. Lotus Organizer and Lotus Notes are trademarks of International Business Machines Corporation.

Use of electronic calendaring systems for purposes such as scheduling meetings or personnel is generally known. Conventional electronic calendar systems allow users, such as a dispatcher, to send electronic scheduling orders to other users, such as a service technician (i.e., a tech), and for that tech receiving a scheduling order to either accept or decline the scheduling order. A scheduling order typically includes a description of the repair to be perform, a location of where the repair will be performed, and possibly an estimate of the scheduled start and end time of the repair order. A repair order decline message may be returned to the dispatcher that issued the scheduling order when the scheduling orders is declined by a requested tech. Likewise, a scheduling order acceptance message may be returned to the dispatcher that issued the scheduling order when the tech accepts the scheduling order. When the tech accepts a scheduling order, the scheduled repair is recorded in the electronic calendar of the accepting tech. Additionally, a record of the calendar of the dispatcher that issued the scheduling order is updated to reflect the expected attendance by the accepting tech.

Conventional task planning tools in a calendaring system allow such users to schedule tasks to be performed by a tech within blocks of time allocated for repair work. The user may also estimate the time needed to complete a task, set start times and due dates for the task, and record the completion of the task. For example, a dispatcher may schedule a block of time for a task against ‘free time’ in the service technician's calendar. The ‘free time’ may include any time in which the service technician does not have a scheduled repair order in his calendar.

In general dispatchers typically schedule service technicians (i.e., techs) using sticky notes, phone calls, spread sheets, or in some cases the above described computer scheduling software which allows easy input and change of the schedule but provide no other meaningful selection aids to the dispatcher.

To address this problem, conventional scheduling software attempts to optimize a schedule by re-evaluating the entire schedule with each new appointment that is received, and by using available, usually inadequate data, and minimal personal input from the dispatchers and techs themselves.

### BRIEF DESCRIPTION OF THE DRAWINGS

FIG. 1 is a schematic block diagram of an exemplary system in which the method in accordance with the invention is implemented;

FIG. 2 is an exemplary screen capture of a Day Schedule Board illustrating the activity of technicians, their appointments, status busy bars of the technicians and unscheduled appointments;

FIG. 3 is an exemplary screen capture of an Active Day Schedule illustrating the progression of appointments;

FIG. 4 is an exemplary screen capture of a page displayed to a technician with appointments;

FIG. 5 is an exemplary screen capture of details of a technician appointment depicted in the screen capture of FIG. 4; and

FIGS. 6(a) and 6(b) is a flowchart of an embodiment of the method in accordance with the invention.

### SUMMARY OF THE INVENTION

Disclosed is a system and method for allowing a dispatcher and/or, a service technician to achieve an optimized schedule for a few or a large number of service technicians performing repairs in the field based on an analysis of past data, methodologies and formulas.

A scheduling program in accordance with the invention is displayed to the dispatcher on the monitor of a computer or any other processing device, such as a personal digital assistant (PDA), mobile device (smartphone) or tablet computer. Using the scheduling program, the dispatcher calls up or accesses the current schedule of all the technicians. At the same time, the technicians can see the entirety of their current schedule, and agree to a current schedule, even placing blocks on dates and times that they are not available for scheduling. This real time data is important for the dispatcher to accurately place new appointments on the schedules of technicians based on the method in accordance with the invention.

New appointments or scheduled appointments allow a “sort” or “match-up” to determine the most optimal technician or technicians and time slots by using a ranking method.

The system includes data servers and session servers that are connected through a real-time communication network, such as the Internet, i.e., a “cloud”, and are accessible over the Internet using protocols and web browsing techniques that are generally known. Cloud computing is a computing model in which computing resources such as storage space and processing power can be remotely managed.

The system also includes at least one hard-wired computer having a browser program that is accessed and displayed to a dispatcher or to a service technician dashboard. The system also includes wireless devices, such as mobile devices (smartphones or PDAs), tablet computers, or other mobile processing devices. The wireless devices include a dispatch or service technician application that permits the optimization of field service appointment scheduling in accordance with the invention. In accordance with the system and method of the invention, schedules are maintained on the cloud and seen simultaneously by the dispatcher and the technicians. Thus, cloud computing allows the use of computing resources (hardware and software) that are delivered as a service over a network (typically the Internet)

The disclosed embodiments of the invention may be used in conjunction with other computer optimization techniques, methodologies and filtering techniques to easily and quickly gain optimized or near optimized solutions in the quickest most economical way possible to provide.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### Detailed Description of the Exemplary Embodiments

Disclosed is a system and method for allowing a dispatcher and/or a service technician to achieve an optimized schedule for a few or a large number of service technicians performing repairs in the field based on an analysis of past data, methodologies and formulas.

FIG. 1 is a schematic block diagram of a system 100 for allowing a dispatcher and/or a service technician to achieve an optimized schedule. With specific reference to FIG. 1, the system 100 includes data servers 120 and session servers 130 that are connected through a real-time communication network, such as the Internet, i.e., a cloud 110, and are accessible over the Internet using protocols and web browsing techniques that are generally known. The data servers 120 comprise computer software and hardware (a database platform) that delivers database services, and performs tasks such as data analysis, storage, data manipulation, archiving, and other tasks using client/server architecture. The session servers 130 permit a dialogue, a conversation or a meeting between two or more communicating devices, or between a computer and user.

The system also includes at least one hard-wired computer 140 that includes a web browser program that is accessed and displayed to a dispatcher or to a service technician dashboard, such as the day schedule board shown in FIG. 2. The system also includes wireless devices 150a . . . 150n, such as mobile devices (smartphones or PDAs), tablet computers, or other mobile processing devices. The wireless devices include a dispatch or service technician application AP that permits the optimization of field service appointment scheduling in accordance with the invention. Cloud computing is a distinctive type of computing that depends on sharing computing resources, rather than having local servers and personal devices for handling applications. The word “cloud” is a metaphor for the Internet in the realm of cloud computing, and this means a type of computing that depends on the Internet. In cloud computing, various services, such as servers, applications and storage are sent to the computers and devices of small to large sized organizations and individuals via the Internet. The goal of cloud computing is to use the high-performance computing power that is usually used by research facilities and the military to perform complex computations.

In accordance with the system and method of the invention, schedules are maintained on the cloud 110 and seen simultaneously by the dispatcher and the technicians. Cloud computing thus allows the use of computing resources (hardware and software) that are delivered as a service over a network (e.g., the Internet).

In accordance with the invention, a scheduling program is displayed to the dispatcher on the monitor of a computer or any other processing device, such as a mobile device (smartphone or PDA) or tablet computer, such as the Day Schedule Board shown in FIG. 2. The Day Schedule Board depicted in FIG. 2 illustrates a schedule activity board having multiple techs, appointments, status busy bars, and unscheduled appointments at the lower end of the Board. The unscheduled appointments are “dragged” and “dropped” into an open slot to schedule a tech for an appointment. It should be noted that the “drag” and “drop” functionality is well known to those skilled in the art.

Using the scheduling program, the dispatcher “calls up” or accesses the current schedule of all the technicians, such as the Active Day Schedule depicted in FIG. 3. Here, the Active Day Schedule shows the progression of appointments from completed jobs from earlier in the day (top of page) to active jobs, where also illustrated are techs en route to appointments, techs en route to obtain parts (i.e., a parts run) and paused jobs, which are all depicted using various colors. At the same time, the technicians can see the entirety of their current schedule, and agree to a current schedule, even placing blocks on dates and times that they are not available for scheduling, as shown in FIG. 4. With reference to FIG. 4, shown therein is an exemplary screen capture of a Technician Dashboard illustrating the initial page that is displayed to the tech, with appointments arranged at the bottom and with action “icons” to view schedule, clock in and clock out, view a customer list(s) (with permission levels), access invoices, company price book and/or place orders for parts. FIG. 5 is an exemplary screen capture of details of a technician appointment depicted in the screen capture of FIG. 4. Here, a working appointment is shown, with the status bar being located at the top of the display, along with customer details and some of the actions that can be taken during the appointment. The real-time data is important for the dispatcher to accurately place new appointments on the schedules of technicians based on the method in accordance with the invention.

New appointments or scheduled appointments allow a “sort” or “match-up” to determine the most optimal technician or technicians and time slots by using a ranking method. The ranking method is defined as the technician and time slot that has the highest value calculated in accordance with the following relationship:

$$Value used for ranking = ( ( Distance Value ) \times ( Distance Significance Value ) ) + ( ( Availability Value ) ) \times ( ( Availability Significance Value ) ) + ( ( Skill Value ) \times ( Skill Significance Value ) ) + ( ( Preference Value ) \times ( Preference Significance Value ) ) + ( ( Priority Value ) \times ( Priority Significance Value ) ) .$$

The Significance Values are set for the entire company that employs the technicians, or are at least constant for this ranking. When the rankings are different than what the dispatcher generally desires, then there are simple algorithms that allow “learning” to occur which change the Significance Values such that the rankings will be more correct during subsequent calculations. For example, learning is based on the previous history of a technician with individual customers, as well as within a geographic area.

The Values (e.g., Distance or Availability) are technician, appointment and time independent, and are created each time an appointment is related to a particular technician at any point on the schedule. Therefore, the computer or other processing device can “sort” from the “Best” to the “Worst” time slots, and dispatchers can immediately determine the best slot and technician for a particular appointment. In addition, if the time slot is wrong or undesired, the method of the invention can “learn” such that a correct time slot, which is different than the wrong or undesired time slot, will be provided the next time a calculation is performed.

In general, the method comprises three major components, i.e., filtering, sorting and hovering. The following exemplary table of appointments shows three service technicians and their current schedule that is displayed to a dispatcher. Such a table can be displayed via a web browser on the monitor of a computer or on any other processing device, such as the mobile device (smartphone or PDA), the tablet computer, or any other wireless device. Here, the dispatcher attempts to place a new unscheduled appointment in a “best slot” of the schedule. The information displayed on the screen, along with additional data provided in accordance with the method of the invention, allows the dispatcher to accomplish the goal of finding the best most optimized slot.

APPOINTMENTS

| TIMES | Service Tech 1 | Service Tech 2 | Service Tech 3 |
|---|---|---|---|
| 8 am | Appoint 1 | SLOT 2 | Appoint 4 |
| 10 am | Appoint 1 | SLOT 2 | Appoint 4 |
| Noon | Appoint 2 | Appoint 3 | SLOT 3 |
| 2 pm | Appoint 2 | Appoint 3 | SLOT 3 |
| 4 pm | SLOT 1 | Appoint 3 | Appoint 5 |

With reference to the above table, a new “Appoint 6” has been received from a customer or other source. While viewing the table, the dispatcher must decide whether to place the recently received appointment in SLOT 1, SLOT 2, or SLOT 3. Placement of the appoint is achieved in accordance with conventional input devices, such as a point and click mouse, touch pad, or via a touch sensitive screen. The operation of such devices are known and will not be described further.

Hovering thus allows the dispatcher to consider information in real time, such as availability, skills, priority, preference and/or proximity, using the above described data and methodology to assisting in placing the newly received appointment at the most optimum position.

AVAILABILITY—The real-time schedule, always updated and transmitted and agreed by the technicians, is depicted as shown above and is displayed on the display screen to at least the dispatcher. In accordance with the method of the invention, schedules are maintained on the Cloud and seen simultaneously by the dispatcher and the technicians. The schedule shows clearly who and when each service technician is available, and therefore the dispatcher may Hover the New Appointment over available slots and place the new appointment at an available slot.

The method of the invention provides functionality such that a new unscheduled appointment, such as Appoint 6, is not allowed to be placed in a slot that is already taken or a slot that is too small to allow it to fit, i.e., there is not enough time to accomplish the appointment as defined.

SKILLS—Each technician can be defined to have certain skills, such as a plumber or an electrician, or both. The appointment may require certain skills, such as a licensed plumber to perform the required work. The method of the invention permits hovering such that the dispatcher is allowed to place the appointment in a slot at which the service technician does not have the proper training or skills to complete the appointment, and allows the dispatcher to see the reason this appointment cannot be placed with a certain technician and can allow an “over-ride” by the dispatcher.

PRIORITY—The “new” unscheduled appointment can have an associated priority level. If the priority level is higher than the priority levels of other appointments already scheduled, then the method of the invention allows the new unscheduled higher priority appointment to be placed on top of lower priority appointments. The lower priority appointments will be removed and placed in an unscheduled list. Here, the dispatcher will be informed that he is placing an appointment in a location at which a previous appointment was located and that he/she is changing the status of the replaced appointment from scheduled to unscheduled. The dispatcher is provided with the choice to place the appointment in a location at which a lower priority appointment was previously located or he/she can place the appointment in an empty appointment slot.

PREFERENCE—In accordance with the method of the invention, as the dispatcher hovers the new unscheduled appointment over an appointment slot associated with a certain service technician, the method of the invention allows the dispatcher to review previously created data that references the customer of the new appointment, and information is presented for viewing the precise preferences of the customer based on their ratings of service technicians from previous appointments that were completed by particular service technicians. The ratings can also be provided by the manager of the service technicians from information gathered by the manager relating to the business, profit of the company, or from the customer, or other sources. A service technician may have a high rating or a low rating. It is also possible for the service technician to be unrated in reference to this certain appointment (or actually the customer of the appointment). This rating and this information may be shown to the dispatcher in real-time in accordance with the method of the invention. Based on the ratings of the service technician, the dispatcher can thus make his decision whether to schedule the service technician for the new unscheduled appointment.

PROXIMITY—Often the most relevant of the information automatically created is the proximity of this new unscheduled appointment to where the technician is physically located at this time, or to where the technician will be at the time he begins to travel to the new unscheduled appointment. In accordance with the method of the invention, the dispatcher hovers at the unscheduled slots 1, 2 or 3, and while the dispatcher hovers the travel distance is calculated by the processor or microprocessor of the computer, smartphone, PDA or tablet computer based on coordinates (e.g., via a calculation), or based on a more complicated calculation using map based technology, such as a global positioning system (GPS). In the preferred embodiment, the calculation can be performed in three different ways.

In a first exemplary embodiment, the distance from Appoint 2 to New Appoint 6 is calculated, and that calculated distance is shown to the dispatcher on the display of the computer, smartphone, PDA or tablet computer.

In a second exemplary embodiment, with reference to the above table that is displayed to the user, a calculation is performed to determine the relevant distance, where the distance in miles from Service Tech 2 to New Appoint 6 is represented as variable a, the distance in miles from New Appoint 6 to Appoint 3 is represented as variable b and the distance in miles from Service Tech 2 to Appoint 3 is represented as variable c. It should be noted that the distance can be represented by any unit of measure, such as feet, kilometers, yards, or the like. It is not the intention to be limited to only one unit of measure, and other units of measure may be used without affecting the scope of the method of the invention.

Using the variables (a), (b), (c), a calculation is performed by the processor or microprocessor of the computer, smartphone, PDA or tablet computer, such that if the relationship (a+b) is less than the relationship (c+b), then a specific color, such as green, is used as a marker and the added distance is depicted on the display of the computer, smartphone, PDA or tablet computer to the dispatcher based in the relationship (a+b−c).

If the relationship (a+b) is greater than the relationship (c+b), on the other hand, then a downward pointing red, arrow is generated and displayed, indicating that the New Appoint 6 should be moved below Appoint 3 for less total distance. The increased distance based on the relationship (a+b−c) may be shown or displayed to the dispatcher and the better distance based on the relationship (c+b) may also be shown or displayed so that the dispatcher knows how much time he would save by switching the time order of the appointments. It should be understood that it is not the intention to be limited to specific colors for providing the indications to the dispatcher, and that any color that provides a noticeable indication can be used. In addition, the shape of the indicator is arbitrary and other shapes may be used to provide indications.

In another exemplary embodiment, the distance in miles from Appoint 4 to New Appoint 6 is represented as variable (a), the distance in miles from the New Appoint 6 to Appoint 5 is represented as variable (b) and the distance in miles from Appoint 4 to Appoint 5 is represented as variable (c). Here, as explained previously, it should be noted that the distance can be represented by any unit of measure, such as feet, kilometers, yards, or the like. It is not the intention to be limited to only one unit of measure, and other units of measure may be used without affecting the scope of the method of the invention.

Using the variables (a), (b), (c), a calculation is performed by the processor or microprocessor such that if (i) the relationship (a+b) is less than (ii) the relationship (c+a) or (iii) the relationship (c+b), then a color, such as Green, is shown or displayed, indicating that the appointment is in the correct slot, and the dispatcher may be shown the total additional distance traveled to make this appointment which is (a+b−c).

If the relationship (c+a) (i.e., relationship (ii)) is the smallest of the three (i.e., relationships (i), (ii) or (iii)), then a red upwardly pointing indicator is shown or displayed to the dispatcher, indicating that it would be best to place the new unscheduled appointment before Appoint 4, and the two distances may be shown to the dispatcher, the distance he is now hovering on, and the closer distance if the two appointments were switched.

If the relationship (c+b) (i.e., relationship (iii)) is the smallest of the three (i.e., relationships (i), (ii) or (iii)), then a Red downwardly pointing indicator is shown or displayed to the dispatcher, indicating that it would be best to place the new unscheduled appointment subsequent to Appoint 5 and the two distances may be shown or displayed to the dispatcher, the distance he is now hovering on, and the closer distance if the two appointments were switched.

AVAILABILITY and PROXIMITY—In alternative embodiments, information from both the Availability and the Proximity may be combined, such that the time in the vacant spot must be greater than the time to travel to and from the vacant spot and the time estimated and required to accomplish the task. If there is not enough time in which to accomplish the task, which includes the travel time, then the program notifies the dispatcher and allows the dispatcher to choose whether to place the appointment in the time deficient slot. Here, the dispatchers may use their own judgment, including the flexibility and priorities of the appointments before and after, and their knowledge of the field service technician. The method of the invention may also inform the dispatcher of how much time is in the slot and how much time appears to be required including the travel time, so that the dispatcher will know the amount of the deficiency.

FIG. 6(a) and FIG. 6(b) is a flowchart of the method in accordance with the invention. The method comprises the step of displaying a table of schedules to the dispatcher, as indicated in step 605. The dispatcher then filters the technicians, as indicated in step 610. Here, the dispatcher may filter the techs for consideration based on the following fields.

Skills: One or more skills, such as Licensed plumber or electrician, may be chosen, and only those techs that have the required skill will be considered and placed on the display screen viewed by the dispatcher.

Companies/Groups: Techs may be placed into certain groups or aligned with certain companies as defined by the dispatcher and only those techs in these groups or companies may be considered and placed on the display screen of the monitor of the computer or other processing device.

Locations: Techs may be aligned by locations or regions, and only those techs assigned in this manner may be placed on the display screen and considered.

Availability: Techs may be filtered by only the techs that have reasonable availability, according to certain guidelines, such as available for at least 2 hours. Filtering in this manner is advantageous, because the dispatcher may seek to keep all of the techs working in a reasonable and balanced manner.

Priority: Techs may be filtered based on only showing the techs that have appointments with a certain priority and above, or based on showing techs that only have appointments with a certain priority and below. Filtering in this manner is advantageously useful for monitoring which techs are actually performing important jobs and for determining whether all the important jobs are being performed.

Other: Here, the dispatcher may possess a multitude of different classes or groups to allow some or all of these groups to be considered and placed on the screen.

It should be noted that any of the above filters may be used individually or together, or even parts of any or all the filter criterion may be used to perform filtering of the techs. It should also be noted that the filter is important for reducing clutter and for permitting organization of the scheduling. The filter also reduces the number of calculations necessary to optimize the remaining techs to their schedules.

In the next step, the dispatcher performs a selection of a new unscheduled appointment (or creates a new one), as indicated in step 615. That is, the dispatcher then attempts to create a new schedule by placing a new unscheduled appointment in a “best slot” of the schedule. If the location at which the dispatcher wishes to place the appointment is apparent, then he/she can “hover” to quickly and easily find the best slot to place the appointment.

With further reference to FIG. 2a(a) and FIG. 2(b), hovering comprises accessing the parameters for selecting a technician, as indicated in step 620.

A calculation is performed by the processor based on the variables (a), (b), (c), to determine the relevant distance, as indicated in step 630. Here, the distance in miles from Service Tech 2 to New Appoint 6 is represented as variable (a), the distance in miles from a new appointment (e.g., New Appoint 6) to another appointment (e.g., Appoint 3) is represented as variable b and the distance in miles from Service Tech 2 to Appoint 3 is represented as variable c. (See Table)

A comparison is then performed to determine whether the relationship (a+b) is less than the relationship (c+b), as indicated in step 635. If the relationship (a+b) is less than the relationship (c+b), then a specific color, such as green, is used as a marker and the added distance is depicted to the dispatcher as value calculated based on the relationship (a+b−c), as indicated in step 640.

The dispatcher then inserts the new appointment at the designated location, as indicated in step 645.

On the other hand, if the relationship (a+b) is greater than the relationship) (c+b), then a downward pointing indicator, such as a red arrow, is generated, indicating that the New Appoint 6 should be moved below Appoint 3 for less total distance, as indicated in step 650 and a return to step 630 occurs. Here, the increased distance that is calculated based on the relationship (a+b−c) may be shown or displayed to the dispatcher and the better distance that is calculated based on the relationship (c+b) may also be shown or displayed so that the dispatcher knows how much time he would save by switching the time order of the appointments.

If, on the other hand, the location at which to place the newly received appointment is not apparent, then the following optimization is performed. Here, a re-sort of the techs is performed, and the most optimal areas to place new unscheduled appointment are highlighted, as indicated in step 655.

To obtain the most optimized task schedule the following variables are considered and the highest scores are used to sort the techs from best to worst, where the best techs are displayed on the far left of the device screen (the primary position) or at the top of the device screen and the worst tech may optionally be left out or not displayed on the primary screen.

The method in accordance with the invention implements a “Learning Algorithm”, i.e., over time and by working with any specific dispatcher, the answer (i.e., the location at which to schedule an appointment), will be more in-line with the way in which the dispatcher handles his scheduling. Here, learning is based on the previous history of a tech with individual customers, as well as within a geographic area. The learning is performed such that the various criteria (i.e., the Significance Values) from prior appointments are added to the ranking method to provide a tech assignment a higher weighting if a technician has previously completed work with a customer or within a geographic area.

Significance Values: Significance values may be set initially at 50 or at any number, and may change as needed based on the dispatchers needs automatically or manually using optimization results.

The variables used to obtain the Significance Value are Distance, Availability, Skill, Preference and/or Priority. It should be understood that other variables may be used and that it is not the intention to be limited to only these variables for performing the optimization.

Distance: If the tech or scheduled appointment of the tech is close to a new unscheduled appointment, then the Distance Value is 10. If the distance is a moderate distance, then the value is set to 5, and if located a great distance away then the value is set to 0. This number is multiplied by the above described Distance Significance Value.

Availability: if a tech's schedule is very open or there are ample slots in which to place appointments, then the Availability Value is 10. If the tech's schedule is moderately open, then the value is set to 5. If the tech's schedule is not open at all, then the value is set to 0 and multiplied by the above described Availability Significance Value.

Skill: if the skill level of a tech is exactly what is required to accomplish the service, then the skill level variable is set to 10. If the skill level of the tech somewhat meets the requirement, then the skill level variable is set to 5. If the skill level of the tech does not meet the requirement at all, then the skill level variable if set to 0, multiplied by the above described Skill Significance Value.

Preference: If the customer or company prefers a specific tech for a specific appointment, then the preference variable is set to 0. If the customer or company does not really care, then the preference variable is set to 5. If the customer or company does not want a specific tech, then the preference variable is set to 0, multiplied by the above described Preference Significance Value.

Priority: If the priority of the new appointment is higher than priorities of appointments that are already scheduled by the tech, then the priority is set to 10. If the priority of the new appointment is equal to priorities of appointments that are already scheduled by the tech, then the priority is set to 5. If the priority of the new appointment is much lower than priorities of appointments that are already scheduled by the tech, then the priority is set to 0, multiplied by the above described Priority Significance Value.

These thus obtained five products (i.e., significance variables) are added together, and the techs are sorted and ranked from the highest to the lowest. The highest ranked techs are placed in the most prominent spot on the display for the dispatcher to consider for the unscheduled appointment.

If the dispatcher chooses a tech that is not in the first or second slots, and the higher slot has a much higher value, then the method of the invention may invoke the computer to “ask” the dispatcher if he/she would consider changing significance values, or whether he/she would accept a suggested change of the significance values by the computer such that the choice made by the dispatcher would have been more correctly guessed using the Significance values. After re-sorting the technicians, the method of the invention then returns to step 620, where the dispatcher implements another hover to complete his choice of the location at which to place the appointment.

The disclosed embodiments of the invention may be used in conjunction with other computer optimization techniques, methodologies and filtering techniques to easily and quickly gain optimized or near optimized solutions in the quickest most economical way possible to provide.

Thus, while there have been shown, described and pointed out fundamental novel features of the invention as applied to a preferred embodiments thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for optimizing field service appointment scheduling, comprising:
displaying a list of technician schedules on a display of a computing device;
filtering the technicians in the displayed list of technician schedules;
creating a new schedule for a technician based on the filtered technicians by selecting an unscheduled appointment in the displayed list of technician schedules;
determining whether the selected unscheduled appointment for the new schedule is an appropriate appointment for the technician; and
performing, by a processor of the computing device, a hover to insert the selected unscheduled appointment into the new schedule for the technician if the selected unscheduled appointment is appropriate for the technician.

2. The method of claim 1, further comprising:
resorting the list of technicians if the selected unscheduled appointment for the new schedule is an inappropriate appointment for the technician.

3. The method of claim 1, wherein said hover comprises:
accessing, by the processor of the computing device, parameters for selecting the technician;
performing a calculation based on the accessed parameters to determine a relevant distance of the technician from the location of the selected unscheduled appointment;
performing, by the processor, a comparison of the parameters to determine whether a first summation parameter of the accessed parameters is less than a second summation parameter of the accessed parameters;
displaying an indicator on the display of the computing device if the first summation parameter is less than the second summation parameter; and
inserting the selected unscheduled appointment for the technician into the new schedule.

4. The method of claim 3, further comprising:
displaying another indicator on the display of the computing device if the first summation parameter is greater than the second summation parameter; and
returning to said performing the calculation based on the accessed parameters to determine the relevant distance of the technician from the location of the selected unscheduled appointment.

5. The method of claim 1, wherein said filtering comprising:
ranking the technicians in the displayed list of technician schedules;
wherein said ranking is performed based on a technician and a time slot having a highest calculated value.

6. The method of claim 5, wherein the value is calculated based on distance, availability, skill, preference and priority.

7. The method of claim 1, wherein a technician schedule is displayed on a display of mobile device simultaneously with the list of technician schedules displayed on the display of the computing device.

8. The method of claim 7, wherein the technician approves the selected unscheduled appointment for the new schedule.

9. The method of claim 1, wherein the technician schedules are maintained on a cloud system and viewed simultaneously by a dispatcher and at least one technician.

10. A system for optimizing field service appointment scheduling, comprising:
a networking including data servers and session servers;
a computing device having a web browser program accessed and displayed on the computing device; and
a plurality of mobile devices communicating with the computing device via the network, each mobile device of the plurality of mobile devices includes an application for optimizing the field service appointments schedules.

11. The system of claim 10, wherein the mobile device is one of a smartphone, a personal digital assistant and a tablet computer.

12. The system of claim 10, wherein the data servers and session servers are arranged in a cloud.

13. The system of claim 11, wherein the application is configured to:
display a list of technician schedules on a display of a computing device;
filter the technicians in the displayed list of technician schedules;
create a new schedule for a technician based on the filtered technicians by selecting an unscheduled appointment in the displayed list of technician schedules;
determine whether the selected unscheduled appointment for the new schedule is an appropriate appointment for the technician; and
perform a hover to insert the selected unscheduled appointment into the new schedule for the technician if the selected unscheduled appointment is appropriate for the technician.

14. The system of claim 11, wherein said hover comprises:
accessing, by the processor of the computing device, parameters for selecting the technician;
performing a calculation based on the accessed parameters to determine a relevant distance of the technician from the selected unscheduled appointment;
performing, by the processor, a comparison of the parameters to determine whether a first summation parameter of the accessed parameters is less than a second summation parameter of the accessed parameters;
displaying an indicator on the display of the computing device if the first summation parameter is less than the second summation parameter; and
inserting the selected unscheduled appointment for the technician into the new schedule.

15. The system of claim 14, wherein another indicator is displayed on the display of the computing device if the first summation parameter is greater than the second summation parameter; and wherein a return to performing the calculation based on the accessed parameters to determine the relevant distance occurs.

16. The system of claim 11, wherein said filtering comprises ranking the technicians in the displayed list of technician schedules, said ranking being based on a technician and a time slot having a highest calculated value.

17. The system of claim 16, wherein the value is calculated based on distance, availability, skill, preference and priority.
